(19) United States
(12) Patent Application Publication
(10) Pub. No.: US 2007/0286034 A1
(43) Pub. Date: Dec. 13, 2007

(54) METHOD OF CONTROLLING AN OPTICAL PICKUP HEAD TO ACCESS AN ECCENTRIC DISC

(75) Inventors: Po-Chen Huang, Hsinchu (TW); Chia-Hao Hsu, Hsinchu (TW); Yuyu Chen, Hsinchu (TW)

Correspondence Address: WPAT, PC, 7225 BEVERLY ST., ANNANDALE, VA, 22003, US

(73) Assignee: LITE-ON IT CORP., Taipei City (TW)

(21) Appl. No.: 11/689,380

(22) Filed: Mar. 21, 2007

(30) Foreign Application Priority Data
Jun. 9, 2006 (TW) 095120691

(51) Int. Cl. G11B 7/00

(52) U.S. Cl. 369/44.11

(57) ABSTRACT

A method of controlling an optical pick-up head to access an eccentric disk. When a loaded disk is determined as an eccentric disk causing a lens of the optical pick-up head crossing between a first track being close to the inner disk and a second track being close to outer disk, a tracking on position has to be concerned. IF a target track is close to the second track, provide a first force to move the lens a distance toward the inner disk then execute a track on operation. IF the target track is close to the first track, provide a second force to move the lens a distance toward the outer disk then execute a track on operation.

### FIELD OF THE INVENTION

The present invention relates to a method of controlling an optical pickup head, and more particularly to a method of controlling an optical pickup head to access an eccentric disc.

### BACKGROUND OF THE INVENTION

FIG. 1 depicts a function block diagram of an optical disc drive, wherein the optical disc drive 100 includes a PUH 10 (optical pickup head). An optical disc 110 includes a center hole for fixing the optical disc 110 on a turn table 122 and the optical disc 110 is then driven to rotate by a spindle motor 120. There are two devices to drive the PUH 10 for a radical movement on the optical disc, the first one is a sled motor 130 to drive a sled 14 for a long-distance movement, and the second one is a tracking coil 140 to drive a lens 12 for a short-distance movement. In addition, a focusing coil 145 is to drive the lens 12 for a focusing-direction movement.

A weak electric signal, generated by the PUH 10 when accessing the optical disc 110, will be processed by a Radio-Frequency Amplifier 150 for generating three output signals, a RF signal (Radio-Frequency signal), a TE signal (Tracking Error signal) and a FE signal (Focusing Error signal), and these three output signals will be sent to a DSP 170 (Digital Signal Processor) for further processing. A first motor driver 160 will output three driving signals via the DSP 170 in response to the TE signal and the FE signal, and these three driving signals will respectively drive the sled motor 130, the tracking coil 140 and the focusing coil 145 to drive the PUH 10 to a correct focusing position and also move the PUH 10 to a correct track along the radial movement of the optical disc. A TRO signal (tracking output signal), outputted from the first motor driver 160 for controlling tracking coil 140, is for driving the lens 12; and a driving signal, outputted from a second motor driver 165 controlled by the DSP 170, is for driving the spindle motor 120 to rotate the optical disc 110 at a correct speed.

In general, there is a movable range on the sled 14 for the moving of the lens 12. For determining the real position of the lens 12 within the movable range, a CSO signal (Central Servo Output signal) is provided by the PUH 10. Generally, the lens 12 will stay at the central position within the movable range if there is no any driving force, therefore, the lens 12 staying at the central position within the movable range indicates the CSO signal outputting a voltage 0V. The lens 12 moving to a specific direction indicates the CSO signal outputting a positive voltage and the positive voltage is increasing with the distance between the real position of the lens 12 and the central position of the movable range; The lens 12 moving to the other direction indicates the CSO signal outputting a negative voltage and the negative voltage is decreasing with the distance between the real position of the lens 12 and the central position of the movable range.

When the optical disc 110 is loaded into the optical disc drive 100, the DSP 170 will control the first motor driver 160 to execute a focusing operation in response to the FE signal, wherein the focusing operation is for driving the focusing coil 145 to focus the lens 12 on a data layer within the optical disc 110, and latterly keeping the lens 12 stably stay on the data layer via a closed-loop control in response to the FE signal.

After the lens 12 is stably focusing on the data layer within the optical disc 110, the optical disc drive 100 will control the PUH 10 jumping to a target track for accessing data. It is understood that the TE signal is a reference for the optical disc drive 100 executing a track jumping operation. During the track jumping operation, a sin waveform will be generated by the TE signal when the focus point of the lens 12 crossing each track, and also the moving direction of the lens 12 can be determined in response to the phase of the sine waveform. There will be 180-degree difference between the phases of two sin waveforms in response to the lens 12 moving toward the inner disc and the outer disc. Therefore, according to the count of the sin waveforms generated by the TE signal and the phase of the sin waveform, the track position of the lens 12 can be determined.

When the lens 12 is moved to the target track, the optical disc drive 100 will immediately execute a track-on operation. The track-on operation is for keeping the focus point of the lens 12 to stay at a track within the optical disc 110 via a closed-loop control in response to the TE signal, and the TE signal will be controlled near a zero cross point in stead of generating a sin waveform. When the lens 12 is stably focusing on a track within the optical disc 110, data on the optical disc 110 can be accessed successfully.

However, an optical disc may be an eccentric disc because of some production problems. For a normal optical disc, the center of a spiral track and the center of the center hole should be the same and there will be no deviation when the optical disc is rotating. Therefore, the lens 12 can stably focus on the track when the lens 12 is accessing data. However, if the optical disc is an eccentric disc, the lens 12 must be deviated along with the deviation of the track to let the lens 12 stably focus on the track. If the rotating speed is up to a limit and the lens 12 cannot deviate along with the track simultaneously, the lens 12 will be out of control and unable to execute the track-on operation, so as the data cannot be accessed correctly.

FIG. 2 depicts a signal diagram within an optical disc drive cannot normally access an eccentric disc. Before the time point t1, the lens is determined as executing a track jumping operation in response to the TE signal. At the time point t1, when the lens is moved around the target track, the optical disc drive is executing a track on operation. After the track on operation is executed, the TRO signal is rapidly changed for trying to control the focus point of the lens to stay on the track. However, as depicted in FIG. 2, the CSO signal indicates the lens is rapidly deviating within the movable range, and the rapid deviation means the lens is out of control. Because the rapid deviation and the TE signal cannot be controlled around the zero cross point, the track on operation of the optical disc drive is determined fail, and the optical disc drive cannot access data correctly.

In general, a test for determining an eccentric disc will be executed after an optical disc is loaded into an optical disc drive. FIG. 3 depicts a relative-movement relationship diagram of an eccentric disc and a lens within an optical disc drive. For explaining easily, each circle in FIG. 3 represents a spiral track, wherein the point C represents the center of each track, the point D represents the center of the central hole 200 of an optical disc, and the circle 210 represents the route of the focus point of the lens crossing tracks when the lens stops moving. Because the central hole 200 is fixed on a turn table of a spindle motor, a deviation of tracks will be generated when the turn table is rotating. The eccentric degree of the optical disc can be determined in response to the TE signal generated by the PUH if the lens is without moving. As depicted in FIG. 3, when the optical disc rotates one cycle, the focus point of the lens will cross from track A to track B, and then cross back from track B to track A. Therefore, the eccentric degree of the optical disc can be determined in response to the count and the phase of the sin waveforms in the TE signal, which means, the optical disc will be determined as an eccentric disc if the count of the sin waveforms in the TE signal is up to a specific limit after the optical disc rotating one cycle.

Conventionally, if an optical disc loaded into an optical disc drive is determined as an eccentric disc, for accessing data correctly, the optical disc drive must reduce the rotating speed for executing a track on operation. Once the rotating speed is too high and up to a limit, the lens operation.

### SUMMARY OF THE INVENTION

The present invention relates to a method for controlling an optical pickup head to access an eccentric disc. When the optical disc drive is executing a track on operation to the eccentric disc, and the lens of the optical disc drive can be controlled around the center of a movable range.

The method for controlling an optical pickup head of an optical disc drive to access an eccentric disc comprises steps of: determining a lens is deviated between a first track and a second track in response to a TE signal when a track on operation is ready to be executed after the optical pickup head is moved to a target track, wherein the first track is closer to an inner disc and the second track is closer to the outer disc of the eccentric disc; moving the lens a distance toward the inner disc of the eccentric disc when a track on operation is executed by the optical disc drive in response to the second track; and executing the track on operation.

In an embodiment, the time for executing the track on operation of the first track is determined by the TE signal having a first phase and the frequency of the TE signal is lower than a threshold frequency.

In an embodiment, the distance is determined by superposing a specific bias voltage to a TRO signal.

In addition, the present invention further provides a method for controlling an optical pickup head of an optical disc drive to access an eccentric disc comprising steps of: determining a lens is deviated between a first track and a second track in response to a TE signal when a track on operation is ready to be executed after the optical pickup head is moved to a target track, wherein the first track is closer to an inner disc and the second track is closer to the outer disc of the eccentric disc; moving the lens a distance toward the outer disc of the eccentric disc when a track on operation is executed by the optical disc drive in response to the first track; and executing the track on operation.

In an embodiment, the time for executing the track on operation of the first track is determined by the TE signal having a first phase and the frequency of the TE signal is lower than a threshold frequency.

In an embodiment, the distance is determined by superposing a specific bias voltage to a TRO signal.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a function block diagram of an optical disc drive.

FIG. 2 is a signal diagram within an optical disc drive cannot successfully access an eccentric optical disc.

FIG. 3 is a related-movement-relationship diagram between an eccentric disc and a lens.

FIG. 4 is a deviation diagram of a TE signal in different tracks.

FIGS. 5A and 5B are signal diagrams within an optical disc drive executing track on operations at different tracks when the optical disc drive accessing an eccentric disc.

FIG. 6 is a flow chart of the present invention of a method of controlling an optical pickup head to access an eccentric disc.

FIG. 7 is a signal diagram within an optical disc drive when a track on operation executed at an outer track after an optical disc drive accessing an eccentric disc in response to the present invention.

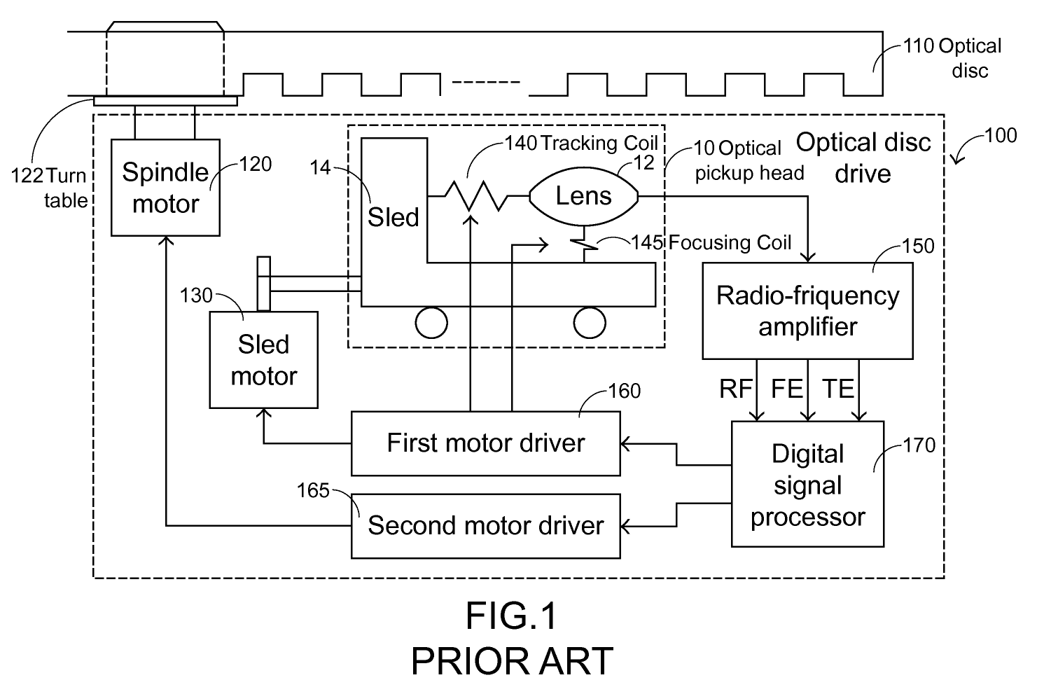

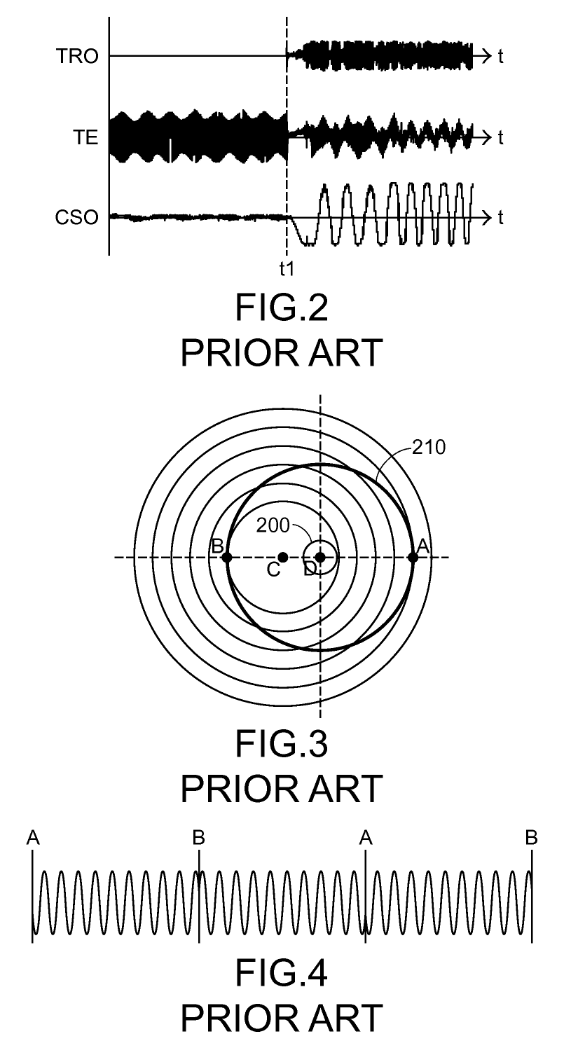

### DETAILED DESCRIPTION OF THE PREFERRED EMBODIMENT

When an optical disc drive is executing a track on operation, the relative speed between a lens of an optical pickup head and a track of an eccentric disc is necessarily concerned because a deviation of track will be generated when the eccentric disc is rotating. It is understood from the FIG. 3, the lowest relative-speed between the lens and the track is happened when the lens is close to track A and track B, so as the track A and track B have a higher opportunity for successfully executing a track on operation.

Moreover, the optical disc drive can determine the track position of the lens in response to the TE signal and determines the time of executing the track on operation. For example, a lens crossing from track A to track B indicates the lens is moving from the outer disc to the inner disc, so as the lens crossing from track B to track A indicates the lens is moving from the inner disc to the outer disc. Therefore, the real position of the lens can be determined by the TE signal. As depicted in FIG. 4, the TE signal has a first phase when the lens crossing from track B to track A, and the TE has a second phase when the lens crossing from track A to track B, wherein there is a 180 degree phase difference between the first phase and the second phase, and the phase-converting point is at the track A or track B. According to a further analyzing of the TE signal, the TE signal has a lowest frequency at the phase-converting point, therefore, track A or track B can be distinguished in response to the phase and frequency of the TE signal, so as the time for executing the track on operation can be determined via the optical disc drive monitoring the TE signal. For example, the lens is determined closing to the track A and the track on operation is ready to execute if the TE signal has a first phase and the frequency of the TE signal is lower than a threshold; the lens is determined closing to the track B and the track on operation is ready to execute if the TE signal has a second phase and the frequency of the TE signal is lower than a threshold.

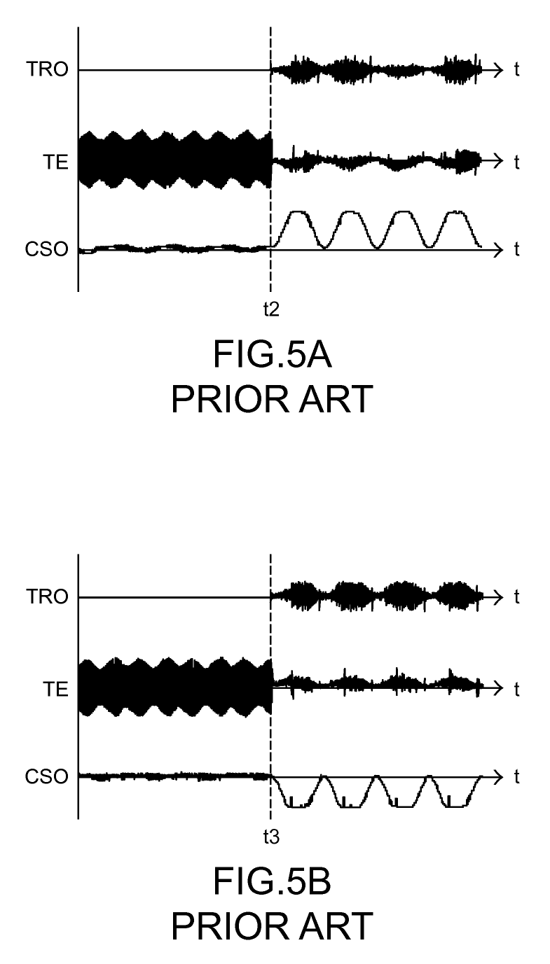

FIGS. 5A and 5B depict two signal diagrams within an optical disc drive when track on operations are executed at two different tracks during the optical disc drive accessing an eccentric disc. As depicted in FIG. 5A, before time point t2, the lens is determined as executing a track jumping operation in response to the TE signal; at time point t2, the lens is determined at track A in response to the TE signal, and then the optical disc drive will execute the track on operation. After the track on operation is executed, the TRO signal is determined to try to control the focus point of lens staying on the track in response to the TRO signal, and also the CSO signal depicts the lens is oscillating at the first side of the movable range. In addition, because the TE signal is at a stable state, the track on operation is determined successful, so as the optical disc drive can access data successfully. In general, the first side of the movable range is the side closer to the outer disc of the optical disc.

As depicted in FIG. 5B, before time point t3, the lens is determined as executing a track jumping operation in response to the TE signal. At time point t3, the lens is determined at track B in response to the TE signal, and then the optical disc drive will execute the track on operation. After the track on operation is executed, the TRO signal is determined to try to control the focus point of lens staying on the track in response to the TRO signal, and also the CSO signal depicts the lens is oscillating at the second side of the movable range. In addition, because the TE signal is at a stable state, the track on operation is determined successful, so as the optical disc drive can access data successfully. In general, the second side of the movable range is the side closer to the inner disc of the optical disc.

However, because the optical disc is an eccentric disc, the two above-described track on operations both result serious RF decent, so as affect the decode function of the optical disc drive when the lens is oscillating at one side of the movable range after track on operation executed.

As depicted in FIGS. 5A and 5B, when the track on operation is executed at different tracks (track A closer to outer disc and track B closer to inner disc) on an eccentric disc, the lens will be controlled at two different sides of the movable range. Therefore, the present invention discloses a method of controlling an optical pickup head to access an eccentric disc. According the present invention, the track position ready for executing the track on operation must be determined first in response to the TE signal. A specific bias voltage must be also superposed to the TRO signal for generating a distance for the lens before the track on operation is executed.

The distance, provided by the specific bias voltage superposed to the TRO, is for preventing the lens being controlled at one side of the movable range. For example, if the track for executing the track on operation is closer to the outer disc, a specific bias voltage, provided by an optical disc drive, will be firstly applied to the TRO signal for moving the lens a distance toward the inner disc for the lens before the track on operation is executed. Because a distance is generated in advance, instead of being controlled at the first side (the side closer to the outer disc) of the movable range, the lens will be controlled at the center of the movable range when the track on operation is executed.

If the track for executing the track on operation is closer to the inner disc, a specific bias voltage, provided by an optical disc drive, will be applied first to the TRO signal for moving the lens a distance toward the outer disc for the lens before the track on operation is executed. Because a distance is generated in advance, instead of being controlled at the second side (the side closer to the inner disc) of the movable range, the lens will be controlled at the center of the movable range when the track on operation is executed.

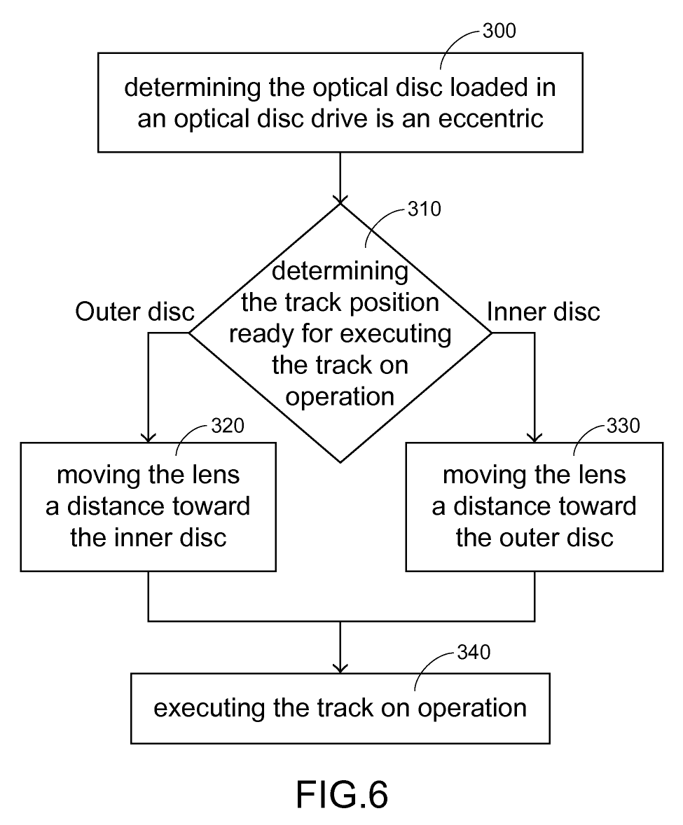

FIG. 6 depicts the flow chart of the method of controlling an optical pickup head to access an eccentric disc of the present invention. The method comprises steps of: determining the optical disc loaded in an optical disc drive is an eccentric (300); determining the track position ready for executing the track on operation (310); moving the lens a distance toward the inner disc if the track on position is closer to the outer disc (320); or moving the lens a distance toward the outer disc if the track on position is closer to the inner disc (330); and executing the track on operation (340).

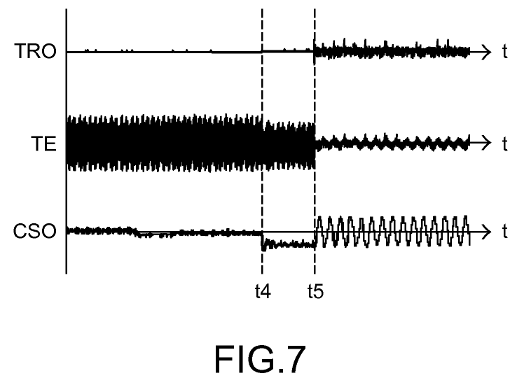

As depicted in FIG. 7, before time point t4, the lens is determined as executing a crossing-track operation in response to the TE signal; at time point t4, the lens is determined at track A in response to the TE signal, and ready for executing the track on operation; between time point t4 and time point t5, the track closer to the outer disc is determined ready for executing the track on operation, and a specific bias voltage, provided by the optical disc drive, is applied (superposed) to the TRO signal for moving the lens a distance toward the inner disc for the lens (in response to the CSO signal); at time point t5, the lens is determined as very close to the outer disc in response to the TE signal, and then the track on operation will be executed. After the track on operation is executed, the TRO signal is determined to try to control the focus point of lens staying on the track in response to the TRO signal, and also the CSO signal depicts the lens is around the center of the movable range. In addition, because the TE signal is at a stable state, the track on operation is determined successful, so as the optical disc drive can access data successfully. Because the lens is controlled at the center of the movable range, the quality of the RF and the decode function of the optical disc driver are much better.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A method of controlling an optical pickup head of a optical disc drive to access an eccentric disc, comprising steps of:
determining a lens is deviated between a first track and a second track in response to a TE signal when a track on operation is ready to be executed after the optical pickup head is moved to a target track, wherein the first track is closer to an inner disc and the second track is closer to the outer disc of the eccentric disc;
moving the lens a distance toward the inner disc of the eccentric disc when a track on operation is executed by the optical disc drive in response to the second track; and
executing the track on operation.

2. The method according to claim 1, wherein the time for executing the track on operation of the first track is determined by the TE signal having a first phase and the frequency of the TE signal is lower than a threshold frequency.

3. The method according to claim 1, wherein the distance is determined by superposing a specific bias voltage to a TRO signal.

4. A method of controlling an optical pickup head of an optical disc drive to access an eccentric disc, comprising steps of:
determining a lens is deviated between a first track and a second track in response to a TE signal when a track on operation is ready to be executed after the optical pickup head is moved to a target track, wherein the first track is closer to an inner disc and the second track is closer to the outer disc of the eccentric disc;
moving the lens a distance toward the outer disc of the eccentric disc when a track on operation is executed by the optical disc drive in response to the first track; and
executing the track on operation.

5. The method according to claim 4, wherein the time for executing the track on operation of the first track is determined by the TE signal having a first phase and the frequency of the TE signal is lower than a threshold frequency.

6. The method according to claim 4, wherein the distance is determined by superposing a specific bias voltage to a TRO signal.
